(19) United States
(12) Patent Application Publication
(10) Pub. No.: US 2021/0104900 A1
(43) Pub. Date: Apr. 8, 2021

(54) POWER BANK

(71) Applicant: CHAN JUNG HSU, Taipei City (TW)

(72) Inventor: CHAN JUNG HSU, Taipei City (TW)

(21) Appl. No.: 16/593,976

(22) Filed: Oct. 5, 2019

(51) Int. Cl. H02J 7/00; H02J 7/02

(52) U.S. Cl. CPC H02J 7/0054; H02J 7/025; H02J 7/0045

(57) ABSTRACT

A power hank is provided that comprises a body, a battery module and a plug assembly. The battery module is mounted inside the body. The plug assembly is pivotally connected to a first end of the body, electrically connects to the battery module, and has a plug, wherein the plug is corresponded to a socket and is configured to allow the battery module charges a mobile device. Accordingly, the power bank of the present invention does not require additional charging cable for charging the mobile device. The pivotal structure of the present invention allows the plug to rotate relative to the body which breaks out the limits of the conventional cover-type power bank.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent Office patent file or records, but otherwise reserves ail copyright rights whatsoever.

### FIELD OF THE INVENTION

The present invention is related to a power bank, and more particularly to a power bank that is able to firmly attached to any specification of mobile device.

### BACKGROUND OF THE INVENTION

With reference to FIGS. 1 and 2, FIG. 1 is an exemplary diagram illustrating a conventional power bank; and FIG. 2 is an exemplary diagram illustrating a conventional cover-type power bank. As shown in FIG. 1, the conventional power bank charges a mobile device 11 through a charging cable 10 from a portable battery 12. The drawback of using such power bank comes from improper wrapping the charging cable 10 that may damage or short the charging cable 10, Moreover, the charging cable 10 is often considered tedious in use. People needs to unwarp the charging cable 50 first and then plug it into both the power bank and the mobile device.

Therefore, as shown in FIG. 2, there's another conventional power bank 2 that improves the above-mentioned charging method by integrating a portable battery 20 with a back cover 21. The back side of the cover 21 has the portable battery 20, and a charging plug 22 is formed at the bottom of the cover 21, which power bank 2. The mobile device is charged through tire charging plug 22. Nevertheless, the cover 21 increases overall weight and thickness, the use of such power hank is convenient, practical and almost the same as the normal use, and thus become popular among people.

However, the drawback of these cover-type power banks 2 (also known as protective battery case) is that such power bank 2 does not allow the people using it with their desired protective case simultaneously, the cover 21 and the portable battery 20 are predefined strictly and integrated together. People use this type of power bank have to carry the weights of the mobile device and the battery all the time. Removal of the power bank will expose the mobile device in unprotective.

Moreover, since the cover-type power bank 2 is predefined strictly, when a new purchased mobile device hits different size (i.e., the width, length and thickness) to the previous one, the cover-type power bank 2 may not applicable to the new mobile device.

Accordingly, there's a need to provide a new power bank that is able to adapt to different size of the mobile device, and thus people are able to use their desired protective ease regardless its size or shape.

### SUMMARY

It is the objective of the present invention to provide a structure of a power bank that addresses the aforementioned and other needs.

According to an aspect of the present invention, the power bank comprises a body, a battery module and a plug. The battery is mounted inside the body. The plug assembly is pivotally connected to a first end of the body, electrically connects to the battery module, and having a plug. The plug is corresponded to a socket and is configured to allow the battery module charges a mobile device.

According to another aspect of the present invention, the power bank comprises a body and a plug assembly. The body comprises a lower cover, an upper cover and a pivotal base. The lower cover is configured to contain a battery module. The upper cover has an protrusion opening and is configured for covering the lower cover. The pivotal base is mounted on the lower cover or foe upper cover corresponded to a first end of the body. The plug assembly has a pivot and a plug. The pivot is pivotally connected to foe pivotal base. The plug is protruded front the protrusion opening toward a second end of the bod. The plug is corresponded to a socket of a mobile device, and charges foe mobile device front the battery module.

According, to yet another aspect of the present invention, the power bank comprises A power bank, comprises a body and a ping assembly. The body has a lower cover, an upper cover and a pivot. The lower cover is configured for containing a battery module. The upper cover has an extrusion opening and is configured to cover the lower cover. The pivot is mounted at the lower cover or foe upper cover corresponded to a first end of the body. The plug assembly has a plug on a side and having a pivotal base on another side. The pivotal base is pivotally connected to the pivot, foe plug assembly electrically connects to the battery module. The plug is corresponded to a socket of a mobile device, and charges the mobile device from the battery module.

Accordingly, regardless foe thickness of the protective ease, the power bank is able to make its plug to rotate relative to the body with the pivotal structure, so that the plug can smoothly inserted into the mobile device. Further, the extrusion force provided by the pivotal structure is able to engage the back of the mobile device onto the power bank.

Therefore, the power bank of the present invention does not require additional charging cable for charging the mobile device, also breaks out the limits of the conventional cover-type power bank that the use requires the mobile device to be “naked” or strictly to a certain specification and/or size of the device.

### BRIEF DESCRIPTION OF THE DRAWINGS

The present invention is illustrated by way of example, and not by way of limitation, in the figures of the accompanying drawings in which like reference numerals refer to the same or similar elements and in which:

FIG. 1 is an exemplary diagram illustrating a conventional power bank;

FIG. 2 is an exemplary diagram illustrating a conventional cover-type power bank;

FIG. 3 is an exemplary diagram illustrating a power bank in accordance with an embodiment of the present invention. In this embodiment;

FIG. 4 is an exemplary diagram of a power bank in accordance with another embodiment of the present invention;

FIG. 5 is an exploded view illustrating a power bank in accordance with other embodiment of the present invention:

FIG. 6 is an exemplary diagram of another view angle of the upper cover illustrated in FIG. 5;

FIG. 7 is an exemplary diagram of a power bank in accordance with other embodiment of the present invention;

FIG. 8A is an exploded diagram of FIG. 7;

FIG. 8B is an exploded diagram of a power bank in accordance with other embodiment of the present invention;

FIG. 9A is an exemplary diagram illustrating a contact portion of a power bank in accordance with an embodiment of the present invention;

FIG. 9B is an exemplary diagram illustrating a contact portion of a power bank in accordance with another embodiment of the present invention; and

FIG. 10 is an exemplary diagram illustrating a foldable stand of the power bank in accordance with an embodiment of the present invention.

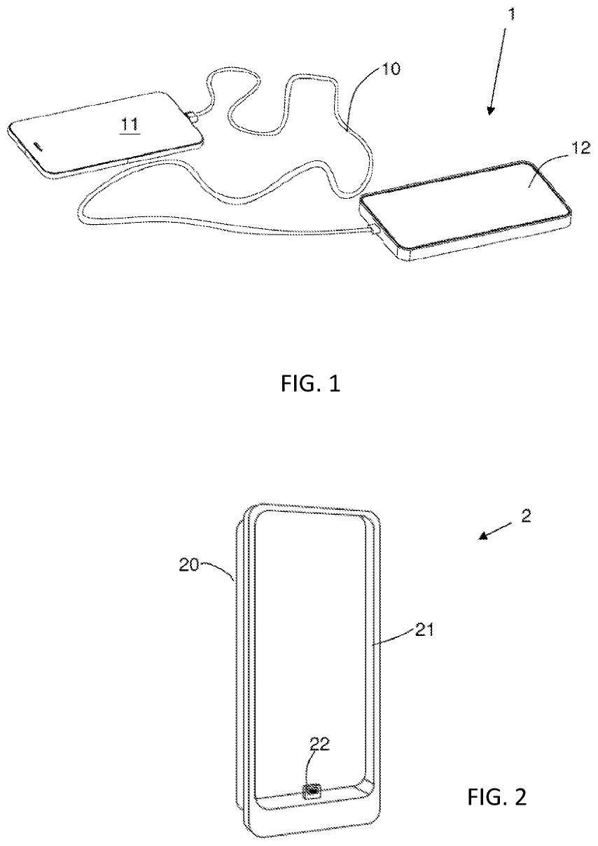

### DETAILED DESCRIPTION

In the following description, embodiments are set forth as examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

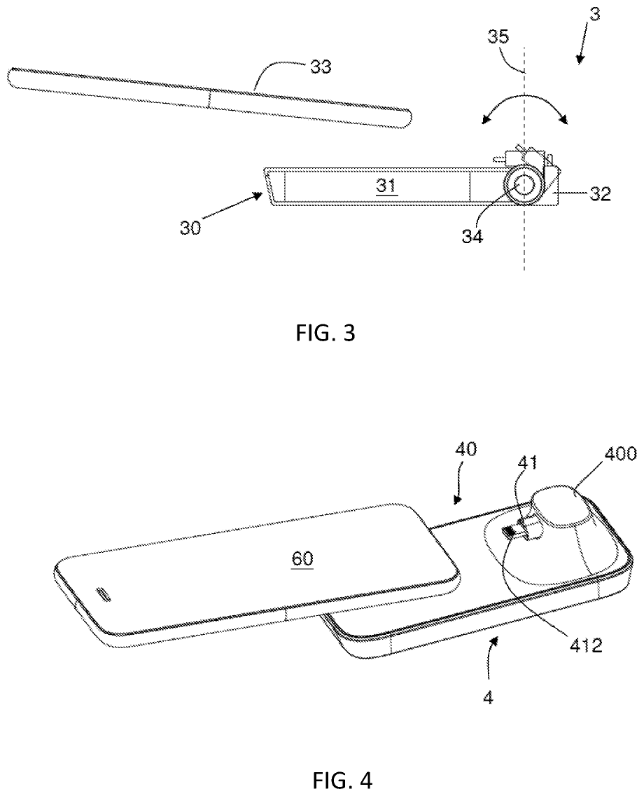

With reference to FIG. 3, FIG. 3 is an exemplary diagram illustrating a power bank in accordance with an embodiment of the present invention. In this embodiment, the power bank 3 comprises a body 30, a battery module 31 and a plug assembly 32. The battery module 31 is placed inside the body 30. The plug assembly 32 is electrically connected to the battery module 31 which is configured to charge a mobile device 33. As shown in FIG. 3, the plug assembly 32 forms a pivotal structure 34 or a clip structure with the body 30, and has a plug. The plug is able to rotate pivotally along the normal line 35 of the body 30 in an angle between −90 to 90 degrees. The plug is corresponded to the socket (not shown) of the mobile device 33. which is configured to inserted into the socket that charges the mobile device 33 from the battery module 31.

Since the plug assembly 32 is pivotally rotatable relative to the body 30 thereby forming the pivotal structure 34, and thus the power bank 3 of the invention is able to adapt for any specification or thickness of the mobile device 33. In an embodiment, the mobile device 33 may be a mobile phone, a tablet or any other similar electronic apparatus.

The power bank of the present invention further comprises a resilient component mounted inside the pivotal structure 34. Upon the resilience of the resilient component that is able provide a clipping force which enhances the robustness of the pivotal structure 34 as attached to the mobile device 33 through the plug. In one embodiment, the resilient component may be a Steering spring (i.e., coil spring).

The battery module 31 may further comprise a wireless charging module. The wireless charging module is able to charge the power bank 3 via an external wireless charging pad.

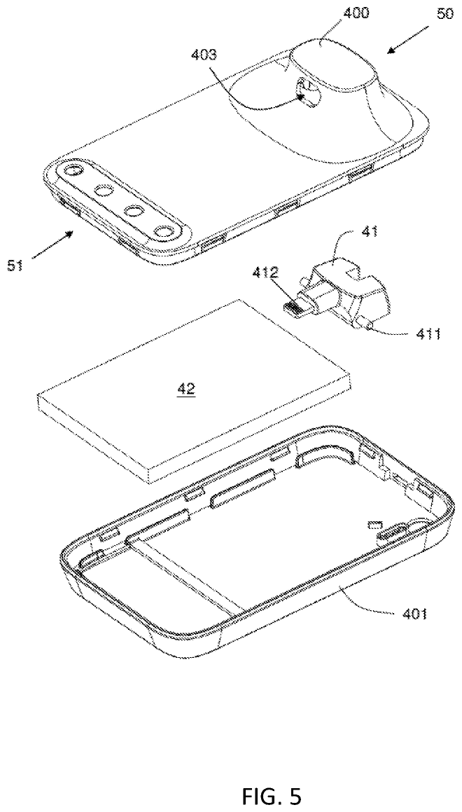

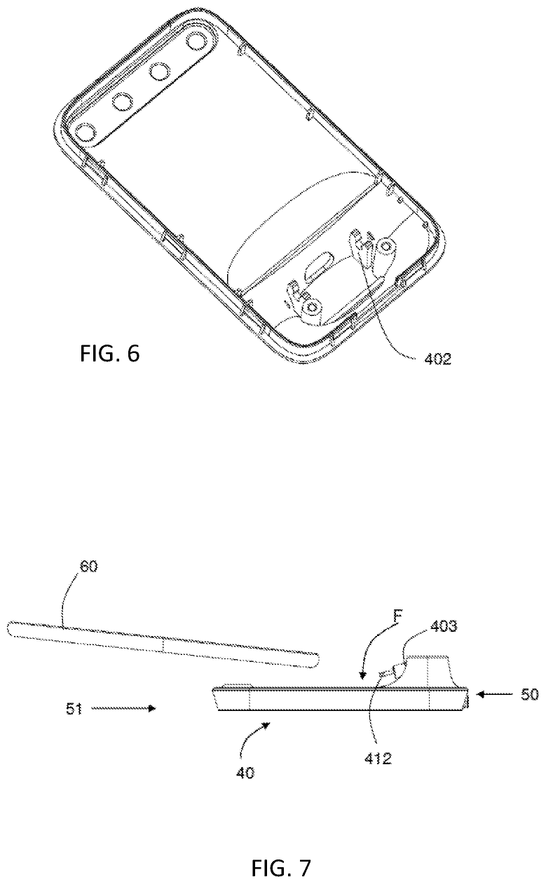

With reference to FIGS. 4, 5 and 6, FIG. 4 is an exemplary diagram of a power bank in accordance with another embodiment of the present invention; FIG. 5 is an exploded view illustrating a power bank in accordance with other embodiment of the present invention; and FIG. 6 is an exemplary diagram of another view angle of the upper cover illustrated in FIG. 5. In this embodiment, the power bank 4 comprises a body 40, a plug assembly 41 and a battery module 42. The body 40 comprises a lower cover 401, an upper cover 400 and a pivotal base 402. The battery module 42 is placed inside the lower cover 401. The tipper cover 400 has a protrusion opening 403 and is configured for covering the lower cover 401. The pivotal structure 402 mounted on the upper cover 400 at a position corresponded to a first end 50 of the body 40.

The plug assembly 41 comprises a pivot 411 and a plug 412. The pivot 411 is pivotally connected to the pivotal base 402 which forms the pivotal structure. The plug 412 is protruded from the protrusion opening 403 toward a second end 51 of the body 40. The plug 412 is corresponding to a socket of a mobile device 60. When the plug 412 is inserted into foe socket, the plug 412 charges the mobile device 60 from the battery module 42.

It is noted that, although, in the described embodiment, the plug assembly has the pivot, and the pivotal base is mounted inside the body, a person skilled in the art will realized that such components are exchangeable. For example, the pivotal base may be formed on the plug assembly, and the pivot may be mounted on the lower cover or the upper cover. Similarly, the pivotal base may selectively be formed on the upper cover or the lower cover, and the pivot may be formed on the plug assembly. Accordingly, in either way, foe pivotal structure is composited of a pivot and a pivotal base which are selectively formed on the upper cover, the lower cover or the plug assembly.

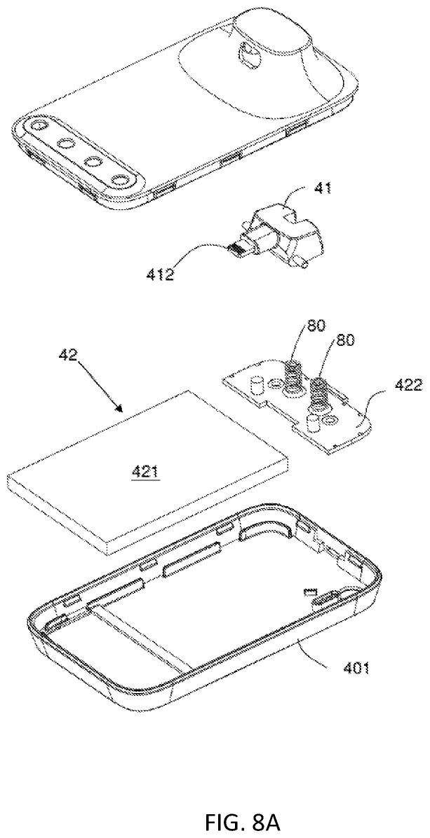

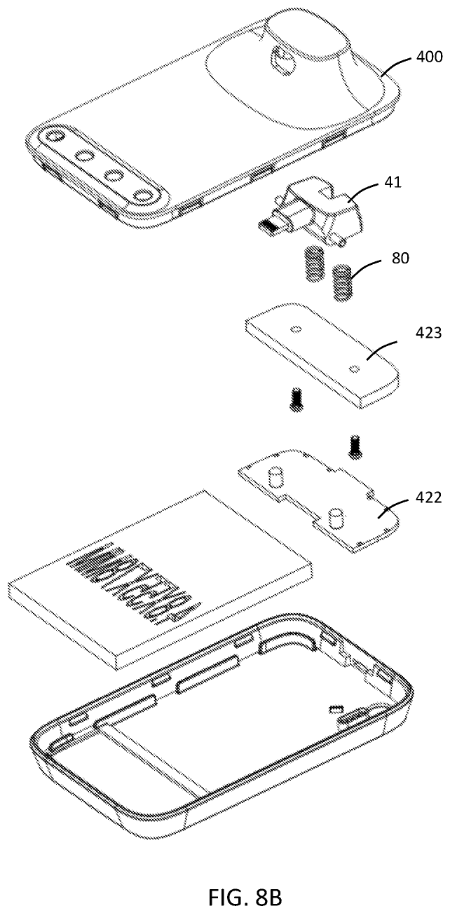

With reference to FIGS. 7 and 8A, FIG. 7 is an exemplary diagram of a power bank in accordance with other embodiment of the present invention; and FIG. 8A is an exploded diagram of FIG. 7. In this embodiment, the power bank further comprises at least one resilient component 80. The seesaw effect will occur on the resilient component 80 and the plug assembly 41. When the resilient component 80 apply a force to the plug assembly 41 at another side of the plug 412, an extrusion force F will occur to make the plug 412 approaching and side with the body 40. In contrast, when the plug 412 is inserted to the mobile device 60, the extrusion force F will firmly engage the mobile device 60 onto the body 40.

In this embodiment, the battery module 42 comprises a battery 421 and a circuit board 422. The battery 421 is placed in the lower cover 401 corresponded to the second end 51 of the body 40. The circuit board 422 electrically connects to the battery 421, and is placed on the first end 50 of the body 40 corresponded to the plug assembly 41. The resilient component 80 is mounted between the circuit board 422 and the plug assembly 41. In this embodiment, the resilient component 80 may be a compression spring that provides an extrusion force P. In one embodiment, the plug 412 is pivotally rotatable corresponded to a horizontal axis of the protrusion opening 403. As shown in FIG. 7, The rotation angle of the plug 412 is between −20 to 20 degrees, preferably −10 to 15 degrees, along the axis of the protrusion opening 403.

It is noted that in FIG. 4, the illustration of the circuit board for the battery module is omitted, which the circuit board is considered to be integrated with the battery. FIG. 8A illustrates the circuit board and the battery separately in order to show that the circuit board can be a baffle panel for the resilient component. In this configuration, it achieves an optimized use of the space. However, the embodiment of FIG. 8A is modifiable to be like FIG. 4 that integrates the circuit board into the battery module, and placed near the second end of the body.

Moreover, with further reference to FIG. 8B. FIG. 8B is an exploded diagram of a power bank in accordance with other embodiment of the present invention. In this embodiment, as shown in FIG. 8B, in order to provide a more efficient way to assemble the components, the power bank further comprises a baffle panel 423 in between the plug assembly 41 find the circuit board 422. The baffle panel 423 is attached to the upper cover 400 with the plug assembly 41, and the resilient component 80 is mounted between the baffle panel 423 and the plug assembly 41. The circuit board 422 is placed under the baffle panel 423.

A person skilled in the art is able to make the resilient component to be located between the upper cover and the lower cover corresponded to the plug assembly. At least one resilient component 80 is adapted for various types of springs including but not limited to a compression spring, extension spring or a C-shaped flat spring.

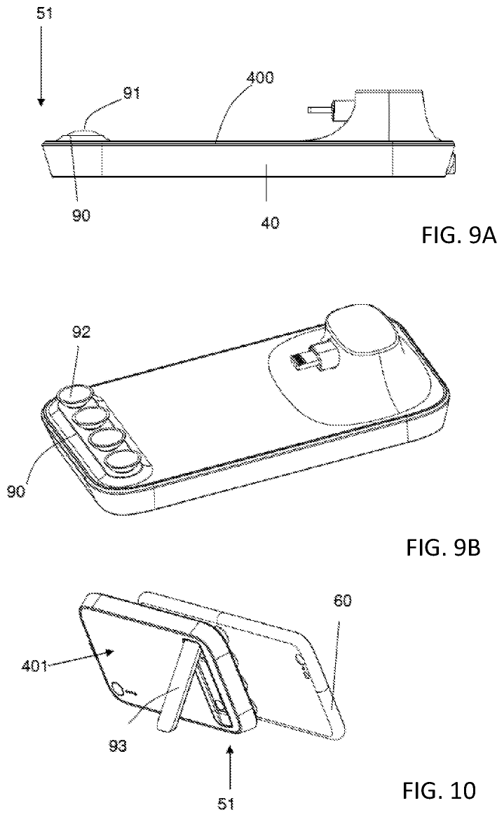

With reference to FIGS. 9A and 9B, FIG. 9A is an exemplary diagram illustrating a contact portion of a power bank in accordance with an embodiment of the present invention; and FIG. 9B is an exemplary diagram illustrating a contact portion of a power bank in accordance with another embodiment of the present invention, in order to make the mobile device is more stable placed on the body, the plug as being a sole support should be avoided. In one embodiment, the upper cover 400 further comprises a contact portion 90 corresponded to the second end 51 of the body 40. The contact portion may be a skidproof mat 91 or a foam having a rough surface. In another embodiment, as shown in FIG. 9B, the contact portion 90 may further comprises a connecting component 92. The connecting component 92 may be a magnet or a suction cup.

With reference to FIG. 10, FIG. 10 is an exemplary diagram illustrating a foldable stand of the power bank in accordance with an embodiment of the present invention. In this embodiment, the power bank further comprises a foldable stand 93. The foldable stand 93 is mounted on the outer surface of the lower cover 401 corresponded to the second end 51 of the body 40. The foldable stand 93 is configured for holding the mobile device 60 in portrait or landscape mode during playing video or listening to the music as being charging simultaneously.

Accordingly, regardless the thickness of the protective case, the power bank is able to make its plug to rotate relative to the body with the pivotal structure, so that the plug can smoothly inserted into the mobile device. Further, the extrusion force provided by the pivotal structure is able to engage the back of the mobile device onto the power bank. Therefore, the power bank of the present invention does not require additional charging cable for charging the mobile device, also breaks out the limits of the conventional cover-type power bank that the use requires the mobile device to be “naked” or strictly to a certain specification and/or size of the device.

The power bank of the present invention further provides a skidproof mechanism such as skidproof rubber, skidproof suction cup or weak adhesive material. When the extrusion force applies to the skidproof mechanism, a stronger anti-slip effect will occur that makes the mobile device, with or without its case, attached firmly onto the power bank.

The present invention solves the inconvenient of using charging cable, and provides a design of a structure that combines the power bank and the mobile device as one increasing the convenience of its portable. The structure of the present invention is adapted for various specifications of devices, with or without the protective cases. People can charge their mobile device in any time, unplug and remove the power bank in any time they want. The practical of the power bank of the present invention is way beyond the conventional cover-type power bank.

While the disclosure has been described in connection with a number of embodiments and implementations, the disclosure is not so limited but covers various obvious modifications and equivalent arrangements, which fall within the purview of the appended claims. Although features of the disclosure are expressed in certain combinations among the claims, it is contemplated that these features can be arranged in any combination and order.

1. A power bank comprising:
a body;
a battery module being mounted inside the body; and
a plug assembly being pivotally connected to a first end of the body, electrically connecting to the battery module, and having a plug, wherein the plug is corresponded to a socket and is configured to allow the battery module charges a mobile device.

2. The power bank as claimed in claim 1, wherein the plug is able to rotate pivotally along the normal line of the body in an angle between −90 to 90 degrees.

3. The power bank as claimed in claim 1, wherein the battery module comprises a battery and a wireless charging module, the wireless charging module charges the power bank via an external wireless charging pad.

4. The power bank as claimed in claim 1, further comprising a resilient component placed inside a pivotal structure, wherein the pivotal structure is formed by the body and the plug assembly.

5. A power bank, comprising:
a body comprising
a lower cover containing a battery module;
an upper cover having an extrusion opening and being configured for covering the lower cover; and
a pivotal base mounted on the lower cover or the upper cover corresponded to a first end of the body; and
a plug assembly having
a pivot being pivotally connected to the pivotal base; and
a plug being protruded from the protrusion opening toward a second end of the body, wherein the plug is corresponded to a socket of a mobile device, and charges the mobile device from the battery module.

6. The power bank as claimed in claim 5, wherein the plug is pivotally rotatable corresponded to a horizontal axis of the protrusion opening, and the rotation angle is between −20 to 20 degrees along the axis.

7. The power bank as claimed in claim 5, further comprising a resilient component, wherein the resilient component is located between the plug assembly and upper cover, or between the plug assembly and lower cover.

8. The power bank as claimed in claim 5, further comprising a resilient component, wherein the battery module comprises a battery and a circuit board, the battery is placed inside the lower cover, and is electrically connected to the circuit board, the circuit board is located at a position corresponded to the first end of the body, and the resilient component is placed between the circuit board and the plug component.

9. The power bank as claimed in claim 8, wherein the resilient component is a spring, compression spring, extension spring or a C-shaped flat spring.

10. The power bank as claimed in claim 5, wherein the upper cover further comprises a contact portion at the second end of the body.

11. The power bank as claimed in claim 10, wherein the contact portion is a skidproof mat.

12. The power bank as claimed in claim 10, wherein the contact portion further comprises at least one connecting component.

13. The power bank as claimed in claim 12, wherein the connecting component is a suction cup structure.

14. The power bank as claimed in claim 4, wherein the mobile device is a mobile phone or a tablet.

15. The power bank as claimed in claim 4, further comprising a foldable stand mounted at out surface of the lower cover.

16. A power bank, comprising:
a body comprising
a lower cover containing a battery module;
an upper cover having an extrusion opening and being configured for covering the lower cover; and
a pivot mounted at the lower cover or the upper cover corresponded to a first end of the body; and
a plug assembly having a plug on a side and having a pivotal base on another side, wherein the pivotal base is pivotally connected to the pivot, the plug assembly electrically connects to the battery module, wherein the plug is corresponded to a socket of a mobile device, and charges the mobile device from the battery module.
